(19) United States
(12) Patent Application Publication
(10) Pub. No.: US 2025/0276526 A1
(43) Pub. Date: Sep. 4, 2025

(54) METHOD FOR MANUFACTURING INK CONTAINER

(71) Applicant: SEIKO EPSON CORPORATION, Tokyo (JP)

(72) Inventors: Takumi NAGASHIMA, Matsumoto-shi (JP); Yoshihiro KOIZUMI, Shiojiri-shi (JP); Takuya MARUYAMA, Matsumoto-shi (JP)

(73) Assignee: SEIKO EPSON CORPORATION, Tokyo (JP)

(21) Appl. No.: 19/065,793

(22) Filed: Feb. 27, 2025

(30) Foreign Application Priority Data
Feb. 29, 2024 (JP) 2024--029617

(51) Int. Cl. B41J 2/175

(52) U.S. Cl. CPC B41J 2/17559

(57) ABSTRACT

A method for manufacturing an ink container includes discharging a parison in a Z-axis direction when a discharge direction of the parison is defined as the Z-axis direction, one direction orthogonal to the Z-axis direction is defined as an X-axis direction, and a direction orthogonal to the Z-axis direction and the X-axis direction is defined as a Y-axis direction, setting a mold by forming the mold by a first mold and a second mold paired with the first mold, the mold including a molding portion having a length in the X-axis direction larger than a length in the Z-axis direction and pinching the parison from both sides in the Y-axis direction by the first mold and the second mold, and molding an ink containing portion by inserting a blow nozzle into an air blowing port of the mold and blowing air.

The present application is based on, and claims priority from JP Application Serial Number 2024-029617, filed Feb. 29, 2024, the disclosure of which is hereby incorporated by reference herein in its entirety.

### BACKGROUND

### 1. Technical Field

The present disclosure relates to a method for manufacturing an ink container.

### 2. Related Art

For example, JP-A-2011-51321 discloses a configuration of a liquid container. According to the document, a base, a front cover, and a rear cover constituting a cartridge case of an ink cartridge are each formed by injection molding, and the respective components are fastened by screwing, snap-fitting, welding, adhesion, or the like.

However, in the liquid container of JP-A-2011-51321, since a plurality of components are formed by injection molding, and these components are fastened by various fastening measures, there are problems in which the number of components and the number of manufacturing steps are large, management of the components is complicated, and a large number of steps and much time are required due to the large number of manufacturing steps.

In other words, there has been a demand for a method for manufacturing an ink container that can manufacture the ink container with a small number of components and a small number of steps.

### SUMMARY

A method for manufacturing an ink container according to an aspect of the present application is a method for manufacturing an ink container including an ink containing portion and an ink supply port in communication with the ink containing portion, the method including discharging a parison in a Z-axis direction when a discharge direction of the parison is defined as the Z-axis direction, one direction orthogonal to the Z-axis direction is defined as an X-axis direction, and a direction orthogonal to the Z-axis direction and the X-axis direction is defined as a Y-axis direction, setting a mold by forming the mold by a first mold and a second mold paired with the first mold, the mold including a molding portion having a length in the X-axis direction larger than a length in the Z-axis direction and pinching the parison from both sides in the Y-axis direction by the first mold and the second mold, and molding the ink containing portion by inserting a blow nozzle into an air blowing port of the mold and blowing air.

### BRIEF DESCRIPTION OF THE DRAWINGS

FIG. 1 is a perspective view of an ink container according to a first embodiment.

FIG. 2 is a sectional view taken along line II-II of FIG. 1.

FIG. 3 is a flow chart illustrating a flow of a method for manufacturing the ink container.

FIG. 4 is a schematic view of a molding apparatus.

FIG. 5 is a sectional view of a parison.

FIG. 6 is an explanatory view of a mold setting step.

FIG. 7 is an explanatory view of a molding step.

FIG. 8 is an enlarged sectional view taken along line VIII-VIII of FIG. 1.

FIG. 9 is an explanatory view of a deburring step.

FIG. 10 is a perspective view illustrating a configuration of a recording apparatus according to a second embodiment.

### DESCRIPTION OF EMBODIMENTS

### First Embodiment

### Configuration of Ink Container

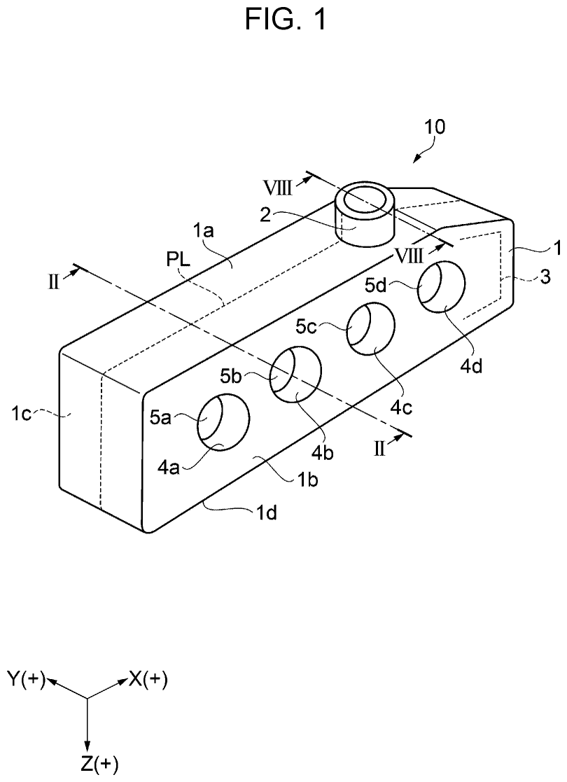

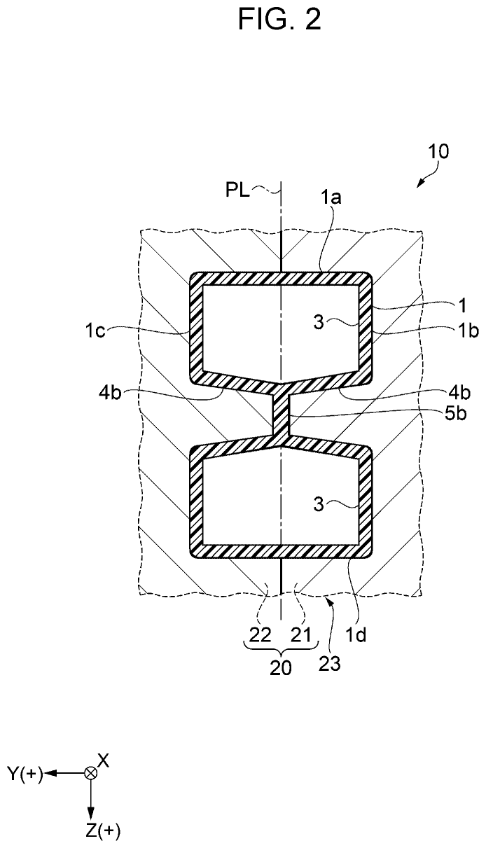

FIG. 1 is a perspective view of an ink container according to a first embodiment. FIG. 2 is a sectional view taken along line II-II of FIG. 1.

A configuration of an ink container 10 according to the present embodiment will be described with reference to FIGS. 1 and 2. In each drawing, an X-axis, a Y-axis, and a Z-axis which are three axes orthogonal to each other are illustrated. In the present embodiment, an extending direction of a long side of the ink container 10 having a rectangular parallelepiped shape is set as an X plus direction. A direction along the X-axis is referred to as an “X-axis direction”, a direction along the Y-axis is referred to as a “Y-axis direction”, and a direction along the Z-axis is referred to as a “Z-axis direction”. For example, the Y-axis direction refers to both a plus side in the Y direction and a minus side in the Y direction. In addition, in each of the following drawings, description may be given with dimensions and scales different from actual dimensions and scales for easy understanding of description.

The ink container 10 is, for example, a storage container that supplies ink to a recording head of an ink jet recording apparatus such as an ink jet printer and is also referred to as an ink cartridge. The ink stored in the ink container 10 is not limited to a material that is called ink and may be any material as long as it becomes a liquid when discharged by the recording head, and the material includes, for example, a DNA sample, a resist, a pattern material, and the like.

In a case of being applied to an ink jet printer, the ink container 10 separately stores each of various colors of ink such as black ink, yellow ink, magenta ink, and cyan ink.

The ink container 10 illustrated in FIG. 1 is integrally formed by blow molding and includes a container body 1 as a container main body, a supply port 2 as an ink supply port, and the like.

The container body 1 includes a storage portion 3 that is a space for storing ink therein. The container body 1 including the storage portion 3 is referred to as an ink containing portion. In the container body 1, a surface on a Z minus side is referred to as an upper surface 1a, a surface on a Y minus side intersecting the upper surface 1a is referred to as a side surface 1b, a surface on a side opposite to the side surface 1b is referred to as a side surface 1c, and a surface on a side opposite to the upper surface 1a is referred to as a lower surface 1d.

The supply port 2 is an ink supply port and is provided on the upper surface 1a of the container body 1. The supply port 2 is in communication with the storage portion 3 of the container body 1. The supply port 2 is provided at a position offset in the X plus direction from a center of the container body 1 in the X-axis direction and protrudes in a cylindrical shape in a Z minus direction from the upper surface 1a.

As illustrated in FIG. 1, the side surface 1b of the container body 1 has a substantially rectangular shape, and an inclined portion is provided on a short side on the supply port 2 side. On the side surface 1b, four recessed portions 4a to 4d are formed in a long-side direction of the side surface 1b. The four recessed portions 4a to 4d are collectively referred to as a recessed portion 4 or recessed portions 4. The four recessed portions 4a to 4d are formed on the side surface 1c in the same manner as on the side surface 1b. The recessed portion 4 has a function of suppressing deformation of walls including the side surfaces 1b and 1c. The number of the recessed portions 4 is not limited to four, may be any number as long as it is more than one, and may be appropriately set in accordance with the size of the container body 1.

FIG. 2 is a sectional view of the recessed portion 4b of the container body 1. As illustrated in FIG. 2, the recessed portion 4b on the side surface 1b side is a truncated cone-shaped recessed portion, and an upper surface thereof is a connecting wall 5b. Similarly, the recessed portion 4b on the side surface 1c side is also a truncated cone-shaped recessed portion, and an upper surface thereof is the connecting wall 5b. That is, the recessed portion 4b on the side surface 1b side and the recessed portion 4b on the side surface 1c side share the connecting wall 5b and are connected to each other. The recessed portions 4a, 4c, and 4d each have the same configuration as the recessed portion 4b, and the recessed portion 4 on the side surface 1b side and the recessed portion 4 on the side surface 1c side share a connecting wall 5 and are connected to each other. With this configuration, even when a pressure inside the storage portion 3 becomes negative, an interval between the side surface 1b and the side surface 1c is maintained, and a predetermined capacity can be ensured.

In FIG. 2, a mold 20 used for blow molding is illustrated by a dotted line.

The mold 20 includes a first mold 21 that forms a portion on the Y minus side including the side surface 1b of the ink container 10 and a second mold 22 that forms a portion on a Y plus side including the side surface 1c of the ink container 10. A dividing position between the first mold 21 and the second mold 22 is a dividing line PL. The dividing line PL is a parting line. A cavity portion of the mold 20 is also referred to as a molding portion 23.

As illustrated in FIG. 2, the recessed portion 4b on the side surface 1b side of the container body 1 is formed by a protrusion protruding in a Y plus direction of the first mold 21. Similarly, the recessed portion 4b on the side surface 1c side is formed by a protrusion protruding in a Y minus direction of the second mold 22. In other words, in the container body 1, a plurality of the recessed portions 4 arranged in the X-axis direction are formed, on each of the side surfaces 1b and 1c facing in the Y-axis direction, by protrusions protruding in the Y-axis direction in the mold 20.

As illustrated in FIG. 1, the ink container 10 molded by the molding portion 23 of the mold 20 has a laterally long shape in which a length in the X-axis direction is larger than a length in the Z-axis direction. In other words, the mold 20 is formed by the first mold 21 and the second mold 22 paired with the first mold 21, and the mold 20 has the molding portion 23 the length in the X-axis direction of which is larger than the length in the Z-axis direction. It is sufficient as long as the recessed portions 4 are holes recessed from the side surfaces 1b and 1c in the Y-axis direction. The recessed portion 4b illustrated in FIG. 2 has a tapered surface in cross section, but may have a linear surface in the Y-axis direction and is not limited thereto. Although a bottom of the recessed portion 4 is illustrated as a vertical plane extending in the Z-axis direction in FIG. 2, it is not limited thereto. Method for Manufacturing Ink Container

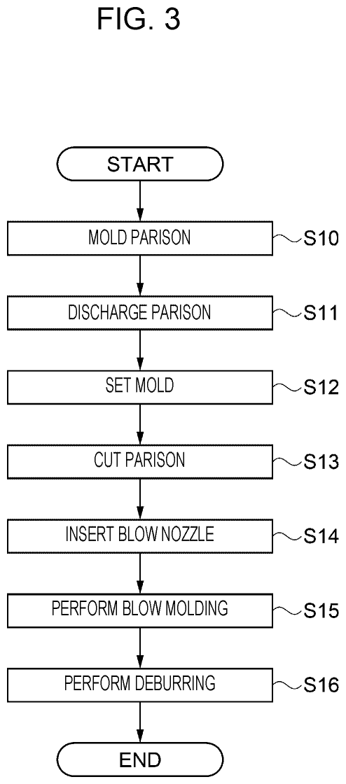

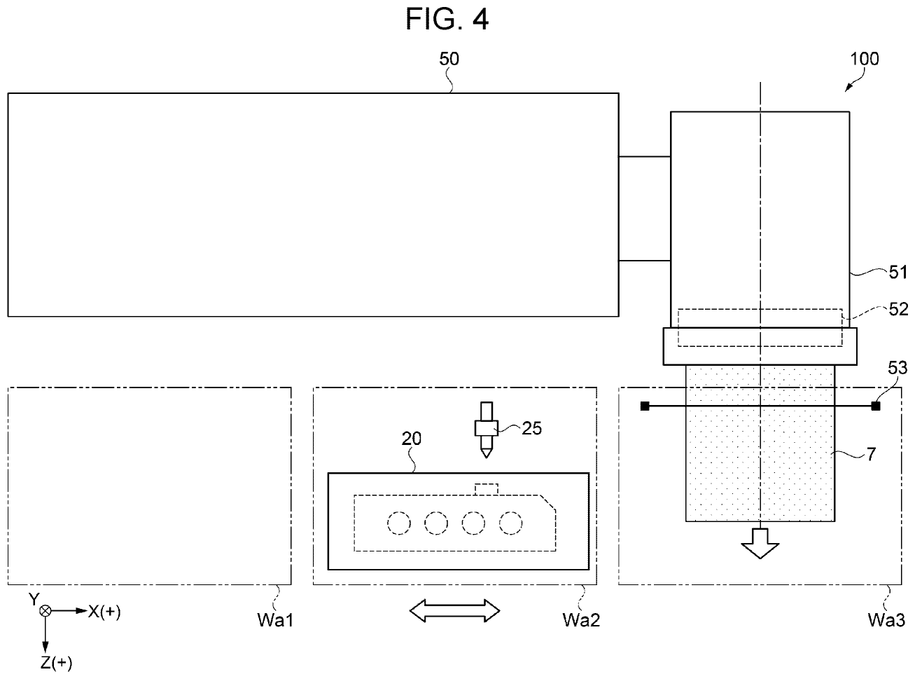

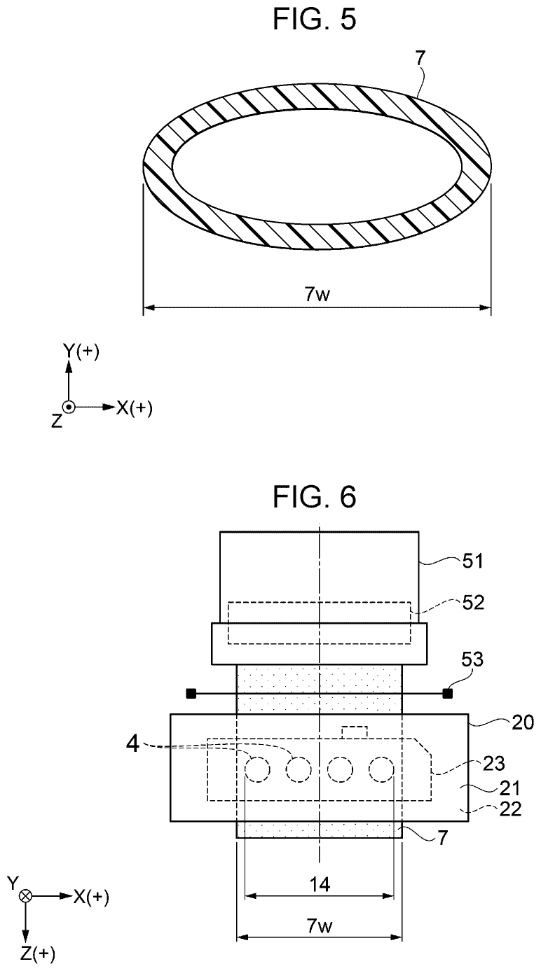

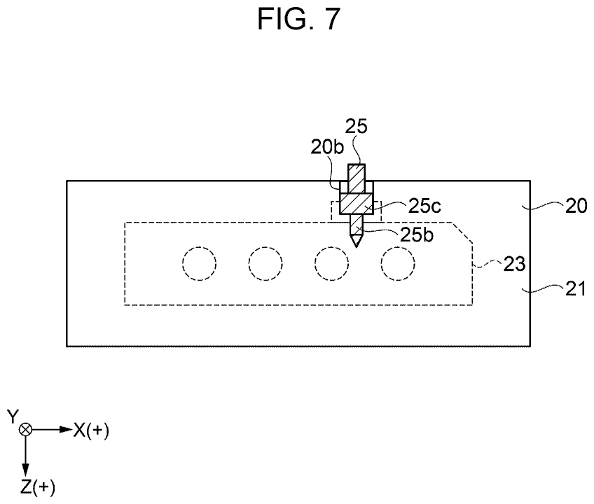

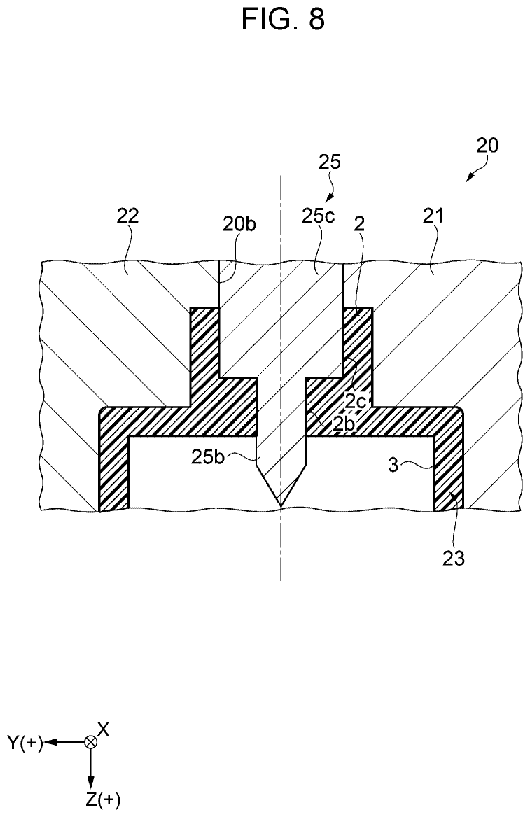

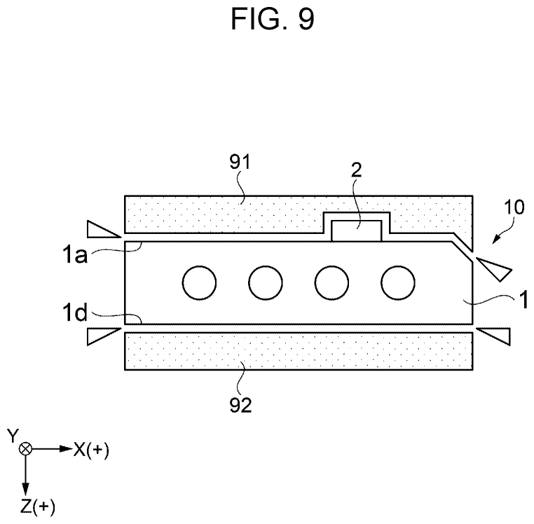

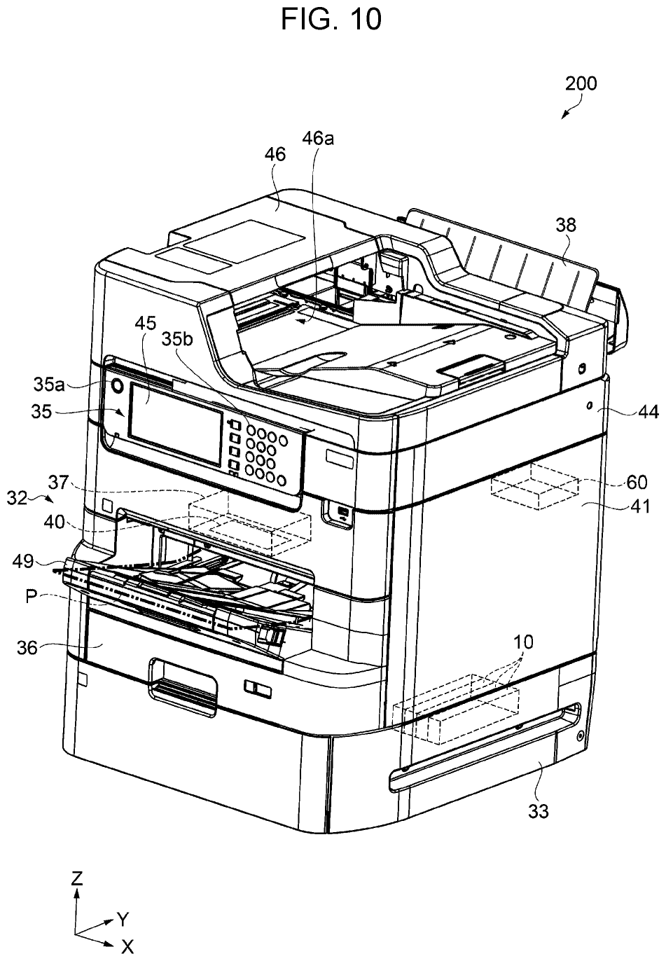

FIG. 3 is a flow chart illustrating a flow of a method for manufacturing the ink container. FIG. 4 is a schematic view of a molding apparatus. FIG. 5 is a sectional view of a parison. FIG. 6 is an explanatory view of a mold setting step. FIG. 7 is an explanatory view of a molding step. FIG. 8 is an enlarged sectional view taken along line VIII-VIII of FIG. 1. FIG. 9 is an explanatory view of a deburring step.

Here, a method for manufacturing the ink container 10 will be described. First, a schematic configuration of a molding apparatus 100 will be described with reference to FIG. 4.

The molding apparatus 100 illustrated in FIG. 4 is a molding apparatus for blow molding and includes a plasticizing device 50, an extruding section 51, and the like. In addition, three work areas Wa1 to Wa3 are provided in a Z plus direction of the molding apparatus 100. The mold 20 is provided so as to be movable in the three work areas Wa1 to Wa3 in the X-axis direction.

The plasticizing device 50 includes a hopper, an extrusion screw, and the like (not illustrated), plasticizes a thermoplastic resin in a pellet form stored in the hopper, and supplies the thermoplastic resin to the extruding section 51. As the thermoplastic resin, for example, a polypropylene (PP) resin for blow molding is used. The material is not limited to the PP resin, and any engineering plastic for blow molding may be used.

The extruding section 51 includes an extruding mold 52, a cutter 53, and the like and extrudes a plasticized material supplied from the plasticizing device 50 in the Z plus direction through the extruding mold 52.

FIG. 5 is a view of a parison 7 viewed in the Z plus direction and is a sectional view of the parison 7 in a plane including the X-axis and the Y-axis. As illustrated in FIG. 5, a cross section of the parison 7 has an elliptical shape having a major axis in the X-axis direction. A width of the ellipse in the major axis direction is defined as a width 7w.

Next, a flow of the method for manufacturing the ink container 10 will be described with reference to FIG. 3.

In step S10, the parison 7 is molded by the molding apparatus 100. Specifically, the plasticized material supplied from the plasticizing device 50 is extruded in the Z plus direction by the extruding section 51.

In step S11, as illustrated in FIG. 4, the tubular parison 7 is discharged from the extruding section 51 in the Z plus direction. This step is a discharging step. When the parison 7 is discharged from the extruding section 51 by a predetermined distance, the mold 20 is moved to the work area Wa3. At this time, the first mold 21 and the second mold 22 (FIG. 6) are separated in the Y-axis direction.

In other words, when a discharge direction of the parison 7 is defined as the Z-axis direction, one direction orthogonal to the Z-axis direction is defined as the X-axis direction, and a direction orthogonal to the Z-axis direction and the X-axis direction is defined as the Y-axis direction, the parison 7 is discharged in the Z-axis direction in the discharging step.

In step S12, as illustrated in FIG. 6, the parison 7 is pinched by the first mold 21 and the second mold 22 from both sides in the Y-axis direction. This step is a mold setting step, in which mold clamping is performed by the first mold 21 and the second mold 22, and the parison 7 having a space therein is set in the molding portion 23 of the mold 20. In other words, in the mold setting step, the parison 7 is pinched by the first mold 21 and the second mold 22 from both sides in the Y-axis direction.

As illustrated in FIG. 6, the width 7w of the parison 7 is set to be larger than an arrangement width 14 of the four recessed portions 4 in the molding portion 23. As a result, both end portions of the parison 7 in the X-axis direction are stretched and become thinner than portions where the four recessed portions 4 are arranged at the time of molding, whereas the portions where the four recessed portions 4 are arranged easily ensure a thickness compared to both the end portions, and it is possible to ensure the strength of the portions where the four recessed portions 4 are arranged. In other words, in the container body 1, the plurality of recessed portions 4 arranged in the X-axis direction are formed, on each of the side surfaces 1b and 1c facing in the Y-axis direction, by the protrusions protruding in the Y-axis direction in the mold 20, and the width 7w of the parison 7 in the X-axis direction is larger than the arrangement width 14 as an arrangement range of the plurality of recessed portions 4.

In step S13, the parison 7 between the extruding section 51 and the mold 20 is cut by the cutter 53. Specifically, as illustrated in FIG. 6, the cutter 53, which is a hot cutter, cuts the parison 7 at a position above the mold 20 by moving from the Y minus direction to the Y plus direction of the parison 7. After the parison 7 is cut, the mold 20 is moved to the work area Wa2.

In step S14, a blow nozzle 25 is inserted into the mold 20 in the work area Wa2. Specifically, as illustrated in FIG. 7, the metal blow nozzle 25 is inserted into an air blowing port 20b of the mold 20. The blow nozzle 25 is provided with a nozzle 25b having a conical portion at a leading end and a flange portion 25c, which is a cylindrical portion thicker than the nozzle 25b. The nozzle 25b is provided with a plurality of air release holes (not illustrated).

In step S15, air is blown into the molding portion 23 of the mold 20 from the blow nozzle 25 so as to mold the ink container 10. This step is a molding step, in which air is injected into the parison 7 in the molding portion 23, and an expanded resin comes into close contact with a wall surface in the molding portion 23 so as to form an outer shape of the ink container 10. In a preferred embodiment, the width 7w of the parison 7 is stretched until it reaches a range of 1.1 to 2 times. At this time, thin portions at both ends of the parison 7 in the X-axis direction have a thickness of 10% or more and 40% or less of the initial thickness of the parison 7. In other words, in the molding step, the blow nozzle 25 is inserted into the air blowing port 20b, and air is blown to mold the container body 1.

FIG. 8 is an enlarged view of a periphery of the supply port 2 in the molding step and corresponds to a cross section taken along line VIII-VIII of FIG. 1. As illustrated in FIG. 8, since the blow nozzle 25 is inserted into the air blowing port 20b of the mold 20 in the molding step, an inner surface of the supply port 2 is molded along an outer shape of the blow nozzle 25. Specifically, the inner surface of the supply port 2 has a two stage structure including a guide hole 2c opened at a top of the supply port 2 and a communication hole 2b formed at a center of a bottom surface of the guide hole 2c. The communication hole 2b allows the guide hole 2c to be in communication with the storage portion 3.

As illustrated in FIG. 8, the communication hole 2b is formed by an outer shape of the nozzle 25b, and the guide hole 2c is formed by an outer shape of the flange portion 25c. As a result, an inner peripheral surface of the supply port 2 including the communication hole 2b and the guide hole 2c can be formed accurately and smoothly. In addition, the outer shape of the supply port 2 is accurately formed along the molding portion 23. In other words, in the molding step, the inner peripheral surface of the supply port 2 as an ink supply port is molded through pressing of the blow nozzle 25 against the resin of the air blowing port 20b. After the molding is finished, the mold 20 is moved to the work area Wa1.

In step S16, a burr 91 of the upper surface 1a and a burr 92 of the lower surface 1d of the ink container 10 are cut off. That is, when the discharge direction of the parison 7 in the Z-axis direction is defined as the Z plus direction, and a direction opposite to the Z plus direction is defined as the Z minus direction, the burr 92 on the Z plus direction side and the burr 91 on the Z minus direction side of a molded product are cut off. Specifically, when the mold 20 is moved to the work area Wa1, mold opening is performed, and the ink container 10 with burrs is taken out. In the ink container 10 that has been taken out, the burr 91 generated along the dividing line PL (FIG. 1) of the upper surface 1a and the burr 92 generated along the dividing line PL of the lower surface 1d are cut off by a dedicated jig (not illustrated). As a result, the ink container 10 illustrated in FIG. 1 is completed. In other words, after the molding step, a deburring step of cutting off the burr 92 on the Z plus direction side and the burr 91 on the Z minus direction side of the molded product is provided, and in the deburring step, burrs of portions excluding the supply port 2 are cut off. That is, the supply port 2 can be molded by the blow nozzle 25 and the mold 20 such that burrs are not produced. The mold 20 after mold opening is moved to the work area Wa3 again, and the processing in step S12 and subsequent steps are repeated.

As described above, according to the method for manufacturing the ink container 10 of the present embodiment, the following effects can be obtained.

The method for manufacturing the ink container 10 is a method for manufacturing the ink container 10 including the container body 1 as an ink containing portion and the supply port 2 as an ink supply port in communication with the storage portion 3 of the container body 1, the method including discharging the parison 7 in the Z-axis direction when the discharge direction of the parison 7 is defined as the Z-axis direction, one direction orthogonal to the Z-axis direction is defined as the X-axis direction, and a direction orthogonal to the Z-axis direction and the X-axis direction is defined as the Y-axis direction, setting the mold by forming the mold 20 by the first mold 21 and the second mold 22 paired with the first mold 21, the mold 20 including the molding portion 23 having a length in the X-axis direction larger than a length in the Z-axis direction and pinching the parison 7 from both sides in the Y-axis direction by the first mold 21 and the second mold 22, and molding the container body 1 by inserting the blow nozzle 25 into the air blowing port 20b of the mold 20 and blowing air.

According to this, it is possible to manufacture the ink container 10, which is laterally long in the X-axis direction, with one member by blow molding and with a small number of steps.

Therefore, it is possible to provide the method for manufacturing the ink container 10 that can manufacture the ink container 10 with a small number of components and a small number of steps.

Moreover, unlike a liquid container in the related art that requires a plurality of components and a large number of manufacturing steps, resulting in increase in the cost, according to the method for manufacturing the ink container 10 of the present embodiment, the ink container 10 can be provided at a low cost because the ink container 10 can be manufactured from one member by blow molding and with a small number of manufacturing steps. In addition, although the ink container 10 has a simple configuration, the ink container 10 has a function equivalent to that of the liquid container in the related art.

In addition, in the molding step, the inner peripheral surface of the supply port 2 as an ink supply port is molded through pressing of the blow nozzle 25 against the resin of the air blowing port 20b.

According to this, since the supply port 2 can be formed while at the same time the container body 1 is molded by blowing air, the ink container 10 can be formed with a small number of manufacturing steps. In addition, since molding is performed through pressing of the blow nozzle 25, the inner peripheral surface of the supply port 2 can be formed accurately and smoothly.

In addition, in the container body 1, the plurality of recessed portions 4 arranged in the X-axis direction are formed, on each of the side surfaces 1b and 1c facing in the Y-axis direction, by the protrusions protruding in the Y-axis direction in the mold 20, and the width 7w of the parison 7 in the X-axis direction is larger than the arrangement width 14 as the arrangement range of the plurality of recessed portions 4.

According to this configuration, both end portions of the parison 7 in the X-axis direction are stretched and become thinner than the portions where the four recessed portions 4 are arranged at the time of molding, whereas the portions where the four recessed portions 4 are arranged easily ensure the thickness compared to both the end portions, and it is possible to ensure the strength of the portions where the four recessed portions 4 are arranged.

In addition, after the molding step, the deburring step for cutting off the upper and lower burrs 91 and 92 in the Z-axis direction of the molded product is provided, and in the deburring step, the burrs of portions excluding the supply port 2 are cut off.

According to this, the supply port 2 can be molded by the blow nozzle 25 and the mold 20 such that burrs are not generated.

The method for manufacturing the ink container 10 is a method for manufacturing the ink container 10 including the container body 1 as an ink containing portion and the supply port 2 as an ink supply port in communication with the storage portion 3 of the container body 1, the method including discharging the parison 7 in the Z-axis direction when the discharge direction of the parison 7 is defined as the Z-axis direction, one direction orthogonal to the Z-axis direction is defined as the X-axis direction, and a direction orthogonal to the Z-axis direction and the X-axis direction is defined as the Y-axis direction, setting the mold by forming the mold 20 by the first mold 21 and the second mold 22 paired with the first mold 21, pinching the parison 7 from both sides in the Y-axis direction by the first mold 21 and the second mold 22, and molding the container body 1 by inserting the blow nozzle 25 into the air blowing port 20b of the mold 20 and blowing air and in the molding of the container body 1, the inner peripheral surface of the supply port 2 as an ink supply port is molded through pressing of the blow nozzle 25 against the resin of the air blowing port 20b.

According to this, since the supply port 2 can be formed while at the same time the container body 1 is molded by blowing air, the ink container 10 can be formed with a small number of manufacturing steps. In addition, since molding is performed through pressing of the blow nozzle 25, the inner peripheral surface of the supply port 2 can be formed accurately and smoothly.

Therefore, it is possible to provide the method for manufacturing the ink container 10 that can manufacture the ink container 10 with a small number of components and a small number of steps.

### Second Embodiment

### Recording Apparatus

FIG. 10 is a perspective view illustrating a configuration of a recording apparatus according to a second embodiment.

A recording apparatus 200 of the present embodiment illustrated in FIG. 10 includes the ink container 10 of the above-described embodiment as an ink cartridge. Hereinafter, the same portions as those in the above-described embodiment are denoted by the same reference numerals, and redundant description will be omitted.

The recording apparatus 200 is, for example, an ink jet printer that performs recording by ejecting ink as a liquid onto a sheet P as a medium.

In FIG. 10, a direction along the X-axis indicates a width direction of the recording apparatus 200, a direction along the Y-axis indicates a depth direction of the recording apparatus 200, and a direction along the Z-axis indicates a height direction of the recording apparatus 200.

As illustrated in FIG. 10, the recording apparatus 200 includes a recording unit 32. The recording unit 32 is accommodated in a housing 41. The recording unit 32 includes a recording head 40 that performs recording on the sheet P and a carriage 37. On a head surface positioned below the recording head 40, a plurality of nozzles are arranged at equal intervals in the direction along the Y-axis. The recording head 40 is mounted on the carriage 37 capable of reciprocating in the direction along the X-axis and performs recording by ejecting ink from the nozzles onto the sheet P while moving in the direction along the X-axis. The sheet P is, for example, plain paper, thin paper, thick paper, coated paper such as photographic paper, or the like.

A document reading device 44 is disposed on the housing 41. The document reading device 44 includes a horizontal document mounting surface made of transparent glass or the like on which a document to be read is mounted, and a lid portion 46 capable of covering the document mounting surface. The lid portion 46 includes an auto document feeder (ADF) and is provided with a paper feed port 46a for feeding a document. Through supplying of a document from the paper feed port 46a, copying, reading, and the like can be easily performed.

An operation section 35 for operating the recording apparatus 200 is provided on a front surface of the recording apparatus 200. The operation section 35 is a panel laterally long in the direction along the X-axis and is provided with a power button 35a that is operated when the recording apparatus 200 is turned on or off, an operation button 35b that is operated when various kinds of operation information are input, and a display panel 45 that can display an operation state, and the like. The display panel 45 is, for example, a liquid crystal panel.

A liquid storage unit 33 is disposed in a lower portion of the recording apparatus 200. In the liquid storage unit 33, a plurality of ink containers 10 according to the above-described embodiment that contain ink to be supplied to the recording head 40 are stored. Tubes (not illustrated) are connected to the ink containers 10, and the ink is supplied to the recording head 40 via the tubes. Through adopting of the ink containers 10 each having a simple configuration as an ink cartridge, the cost can be suppressed.

A sheet setting portion 38 in which a sheet can be set is disposed on a rear surface of the recording apparatus 200. The sheet set in the sheet setting portion 38 can be transported to the recording head 40 side by a sheet transport section (not illustrated) including a transport roller and the like.

In addition, a paper feed cassette 36 for storing the sheet P is provided below the recording unit 32. The sheet P accommodated in the paper feed cassette 36 can be transported to the recording head 40 side by the sheet transport section including the transport roller and the like.

The sheet P on which recording has been performed by the recording head 40 is transported by a transport section (not illustrated) and is discharged to a paper discharge tray 49 provided downstream of the recording head 40 in a transport direction. The paper discharge tray 49 is disposed above the paper feed cassette 36. The discharged sheet P is stacked on the paper discharge tray 49.

The recording apparatus 200 includes a controller 60. The controller 60 controls the carriage 37, the recording head 40, the transport section, the document reading device 44, the display panel 45, and the like. The controller 60 includes hardware such as a central processing unit (CPU), a read only memory (ROM), and a random access memory (RAM). The controller 60 controls the recording apparatus 200 by causing the CPU to execute a predetermined control program. The ROM is a nonvolatile storage device and stores a control program executed by the CPU and data processed by the control program. The RAM constitutes a work area of the CPU. The CPU expands a control program read from the ROM or the like in the RAM, executes the expanded control program, and controls the recording apparatus 200.

What is claimed is:

1. A method for manufacturing an ink container including an ink containing portion and an ink supply port in communication with the ink containing portion, the method comprising:
discharging a parison in a Z-axis direction when a discharge direction of the parison is defined as the Z-axis direction, one direction orthogonal to the Z-axis direction is defined as an X-axis direction, and a direction orthogonal to the Z-axis direction and the X-axis direction is defined as a Y-axis direction;
setting a mold by forming the mold by a first mold and a second mold paired with the first mold, the mold including a molding portion having a length in the X-axis direction larger than a length in the Z-axis direction and pinching the parison from both sides in the Y-axis direction by the first mold and the second mold; and
molding the ink containing portion by inserting a blow nozzle into an air blowing port of the mold and blowing air.

2. The method for manufacturing an ink container according to claim 1, wherein
in the molding, an inner peripheral surface of the ink supply port is molded through pressing of the blow nozzle against a resin of the air blowing port.

3. The method for manufacturing an ink container according to claim 1, wherein
in the ink containing portion, a plurality of recessed portions arranged in the X-axis direction are formed on a side surface facing in the Y-axis direction by protrusions protruding in the Y-axis direction in the mold, and
a width of the parison in the X-axis direction is larger than an arrangement range of the plurality of recessed portions.

4. The method for manufacturing an ink container according to claim 1, further comprising:
deburring, when the discharge direction of the parison in the Z-axis direction is defined as a Z plus direction, and a direction opposite to the Z plus direction is defined as a Z minus direction, by cutting off a burr on the Z plus direction side and a burr on the Z minus direction side of a molded product after the molding, wherein
in the deburring, the burrs of portions excluding the ink supply port are cut off.

5. A method for manufacturing an ink container including an ink containing portion and an ink supply port in communication with the ink containing portion, the method comprising:
discharging a parison in a Z-axis direction when a discharge direction of the parison is defined as the Z-axis direction, one direction orthogonal to the Z-axis direction is defined as an X-axis direction, and a direction orthogonal to the Z-axis direction and the X-axis direction is defined as a Y-axis direction;
setting a mold by forming the mold by a first mold and a second mold paired with the first mold and pinching the parison from both sides in the Y-axis direction by the first mold and the second mold; and
molding the ink containing portion by inserting a blow nozzle into an air blowing port of the mold and blowing air, wherein
in the molding of the ink containing portion, an inner peripheral surface of the ink supply port is molded through pressing of the blow nozzle against a resin of the air blowing port.
